(19) United States
(12) Patent Application Publication
(10) Pub. No.: US 2014/0230582 A1
(43) Pub. Date: Aug. 21, 2014

(54) ACTUATING APPARATUS

(71) Applicants: Andres Toennesmann, Aachen (DE); Andreas Koester, Essen (DE); Martin Nowak, Leverkusen (DE); Michael Schaefer, Kremmen (DE); Michael Breuer, Simmerath (DE)

(72) Inventors: Andres Toennesmann, Aachen (DE); Andreas Koester, Essen (DE); Martin Nowak, Leverkusen (DE); Michael Schaefer, Kremmen (DE); Michael Breuer, Simmerath (DE)

(73) Assignee: PIERBURG GMBH, NEUSS (DE)

(21) Appl. No.: 14/348,055

(22) PCT Filed: Jul. 17, 2012
(86) PCT No.: PCT/EP2012/063978

§ 371 Date: Mar. 28, 2014

(30) Foreign Application Priority Data
Sep. 30, 2011 (DE) 10 2011 054 082.2

(51) Int. Cl. F16H 19/02

(52) U.S. Cl. CPC F16H 19/02
USPC 74/25

(57) ABSTRACT

An actuating apparatus includes a housing, an actuating unit, a receiver element, and a transmitter element. The actuating unit comprises a first end with a circular arc-shaped contour whose circular arc central axis is configured to act as a first pivot axis. The actuating unit is configured to be moved via an actuator and to undertake a translational main movement and a pivoting movement. The translational main movement is superimposed by the pivoting movement. The receiver element is fixedly arranged in the housing. The transmitter element comprises a magnetic field. The transmitter element is configured to be translationally movable, to be biased so as to bear against the first end of the actuating unit, and to cooperate with the receiver element.

### CROSS REFERENCE TO PRIOR APPLICATIONS

This application is a U.S. National Phase application under 35 U.S.C. §371 of International Application No. PCT/EP2012/063978, filed on Jul. 17, 2012 and which claims benefit to German Patent Application No. 10 2011 054 082.2, filed on Sep. 30, 2011. The International Application was published in German on Apr. 4, 2013 as WO 2013/045132 A1 under PCT Article 21(2).

### FIELD

The present invention relates to an actuating apparatus with an actuating unit which is movable via an actuator, whose translational main movement is superimposed by a pivoting movement, a translationally movable transmitter element with a magnetic field which bears on a first end of the actuating unit in a pressure-loaded manner and which cooperates with a receiver element fixedly arranged in a housing.

### BACKGROUND

In the field of vehicle construction, such actuating apparatuses can find many applications in the context of an internal combustion engine. Exhaust gas recirculation valves, waste gate valves, register flaps or VNT actuators can, for example, be driven by such actuation apparatuses.

These actuating apparatuses have an electric motor as the drive unit via which a transmission and a downstream crank is driven or via which a crank is driven directly. The crank is operatively connected with a slotted guide plate in a drive element acting in a rotator manner, via which the movement of the electric motor is converted into a substantially linear movement of an actuating element. In contrast to linear, pneumatically, or electromagnetically operated actuators, electromotive actuators allow for a finer positioning of the downstream actuating element, as well as for a greater actuating force by varying the rotatory lever, which effect can be intensified further by an intermediate transmission.

It is reasonable for various reasons not to convert the rotational movement into an exclusively linear movement of the downstream actuating element, but to also allow radial movement components. This can reduce production and assembly costs.

U.S. Pat. No. 6,886,546 B1 describes a rotationally operated poppet valve whose valve rod is not exclusively moved rotationally and is not moved in a plain bearing, but also has movement components radial to the main direction of movement.

The position of the actuating element must be known in order to be able to control such an actuating apparatus as desired. A magnet is usually coupled with a Hall sensor for this purpose. The measurement is contactless and thus free of wear. The measurement can be provided directly at the drive or at transmission components which has the advantage that, in applications under high thermal loads, such as exhaust gas recirculation valves, the magnet and the Hall sensor cannot be damaged by the occurring high temperatures. This positioning has the disadvantage, however, that tolerances in the drive components cause a high measuring inaccuracy. For this reason, it is attempted to determine the position of the actuating element directly at the actuating element or at a component making the same linear movement as the actuating element.

DE 10 2009 054 311 A1 describes a valve device in which a rotational movement of an actuator is converted into a translational movement of an adjusting element adjusting the valve, wherein the position of the actuating element is determined using a carrier element rigidly connected with the adjusting element and carrying the magnet, and a contactless sensor measuring the position of the magnet.

Since the movement in this case is not, however, purely translational, which would compromise a measurement using only one sensor, at least two sensors are required in order to first determine the spatial position of the actuator element and to calculate the translational proportion therefrom. The use of two sensors entails higher material costs.

### SUMMARY

An aspect of the present invention is to provide an actuating device having an actuating unit which can be moved via an actuator, the translational main movement of which is superimposed by a pivoting movement, wherein it is possible to determine the exact position of the actuating element in a simple and economic manner.

An actuating apparatus includes a housing, an actuating unit, a receiver element, and a transmitter element. The actuating unit comprises a first end with a circular arc-shaped contour whose circular arc central axis is configured to act as a first pivot axis. The actuating unit is configured to be moved via an actuator and to undertake a translational main movement and a pivoting movement. The translational main movement is superimposed by the pivoting movement. The receiver element is fixedly arranged in the housing. The transmitter element comprises a magnetic field. The transmitter element is configured to be translationally movable, to be biased so as to bear against the first end of the actuating unit, and to cooperate with the receiver element.

### BRIEF DESCRIPTION OF THE DRAWINGS

The present invention is described in greater detail below on the basis of embodiments and of the drawings in which:

FIG. 1: shows a side elevational view of an actuating device of the present invention, illustrated in section; and

FIG. 2: shows a side elevational view of the actuating device of the present invention in FIG. 1, illustrated in partial section.

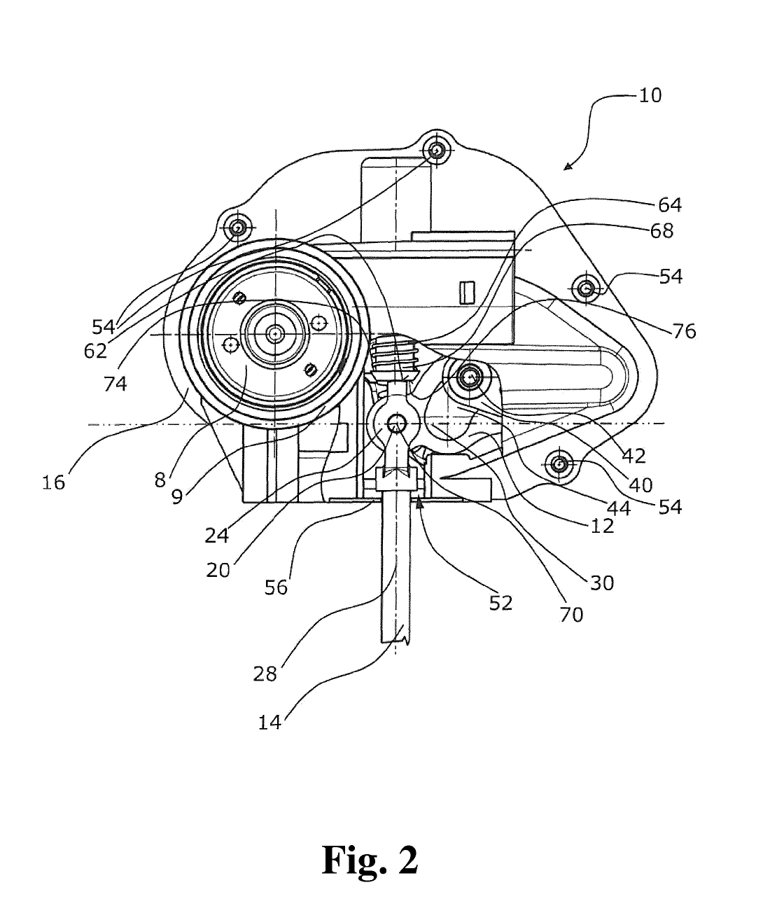

### DETAILED DESCRIPTION

Only the translational component of the movement of the actuator unit is measured because the first end of the actuating unit has a circular-arc shaped contour, where the central axis of the circular arc is a first pivot axis. The necessity of using two Hall sensors measuring the movement of the actuating elements in two mutually perpendicular directions is therefore obsolete. The material costs are therefore reduced, and the calculation of the translational component of movement is avoided. The reliability of the sensor unit is further doubled due to the omission of one of the sensors.

In an embodiment of the present invention, the first pivot axis can, for example, be the central axis of a cylindrical bearing pin. The pivoting movement of the actuating element can thereby be realized in a simple manner.

In an embodiment of the present invention, the transmitter element can, for example, be a magnet or a carrier element with a magnet. This has the advantage that a magnet is particularly well suited for a contactless measurement and can be positioned freely in the carrier element, thereby providing more room for positioning the receiver element.

In an embodiment of the present invention, a spherical segment shaped surface can, for example, be formed at the first end of the actuating unit whose center is the intersection of the first pivot axis and a second pivot axis orthogonal to the first pivot axis. It is thereby possible to compensate for pivoting movements in all directions orthogonal to the translational main direction of movement of the actuating unit in order to measure only the translational component.

In an embodiment of the present invention, the first end of the actuating unit can, for example, be a rod head fastened to an actuating element. The contour can be formed particularly easily on the surface of the rod head.

In an embodiment of the present invention, the housing can, for example, be provided with a stationary guide for the transmitter element. The magnet thereby makes exactly the same translational movement as the actuating unit.

In an embodiment of the present invention, the guide can, for example, be formed integrally with the housing. The number of parts required is thus reduced and, as a consequence, the material and assembly costs are also reduced.

In an embodiment of the present invention, a resilient element can, for example, directly or indirectly bias the transmitter element against the first end of the actuating unit. This has the advantage that the magnet is always, even against the action of gravity, moved in proportion to the translational main direction of movement of the actuating unit.

In an embodiment of the present invention, the resilient element can, for example, be a spring. A spring is corrosion-resistant and also thermally resistant.

In an embodiment of the present invention, the transmitter element can, for example, be at least partially hollow and be closed on its side facing the actuating unit. A part of the spring and of the guide can thus be disposed in the transmitter element, whereby the structural space required is reduced.

In an embodiment of the present invention, the spring can, for example, surround the transmitter element. The spring is thereby guided and a kinking of the spring prevented.

In embodiment of the present invention, the spring can, for example, at least partially be surrounded by the guide and abut against the housing. This has the advantage that the spring is protected against the outside.

In an embodiment of the present invention, the guide can, for example, be at least partially surrounded by the spring. This is advantageous in that less material and structural space is required for the guide.

In an embodiment of the present invention, the transmitter element can, for example, at least partially surround the guide. The transmitter element can thereby be guided in a particularly safe manner and, at the same time, can no longer get caught in the windings of the spring.

In an embodiment of the present invention, the guide can, for example, at least partially surround the transmitter element. This allows for the realization of stable guides.

In an embodiment of the present invention, a thermally insulating element can, for example, be arranged between the magnet and the actuating unit. The thermal load on the magnet is thereby reduced, whereby its durability is enhanced.

In an embodiment of the present invention, the transmitter element can, for example, have a circumferential protrusion on its side facing the actuating unit, the protrusion being biased by the spring. The spring can thereby surround the guide and the transmitter element, thereby simplifying assembly.

In an embodiment of the present invention, the thermally insulating element can, for example, be formed integrally with the rod head or be formed integrally with the transmitter element. The number of parts used is thus reduced, thereby reducing assembly costs.

In an embodiment of the present invention, the sensor can, for example, be cast or injection molded into the housing. This has the advantage of protecting the sensor from environmental influences.

An actuating device is thus provided which allows for an exact determination of the translational component of movement of the not purely translational movement of the actuating unit in an economic and simple manner.

Further features and an embodiment are hereinafter described with reference to the drawings.

The actuating device 10 is composed of a two-piece housing 16 in which an electric motor, serving as the drive unit 8, is arranged in a correspondingly shaped seat 9 in the housing 16. The housing 16 is of a two-piece structure, the two housing halves being fixedly connected with each other by housing screws 54.

Via a transmission (not illustrated), the drive unit 8 drives an input shaft s(not illustrated), on which an eccentric 40 is mounted, with an eccentric output bolt 42 being fastened at the opposite end thereof, the eccentric output bolt 42 extending in parallel with the input shaft so that the input shaft, the eccentric output bolt 42 and the eccentric 40 form a crank.

A bearing (not illustrated) is arranged on the eccentric output bolt 42, which bearing rolls in a slotted guide plate 44 of a drive element 12.

The drive element 12 is substantially of a disc-shaped design and is provided with a bore in a first end portion (not visible in the drawings), through which bore a rotation axis extends in the form of a bolt rotationally supported in bearings, the bolt being fixedly connected with the drive element 12 so that the drive element 12 is rotatably supported along the plane of its extension by means of bearings.

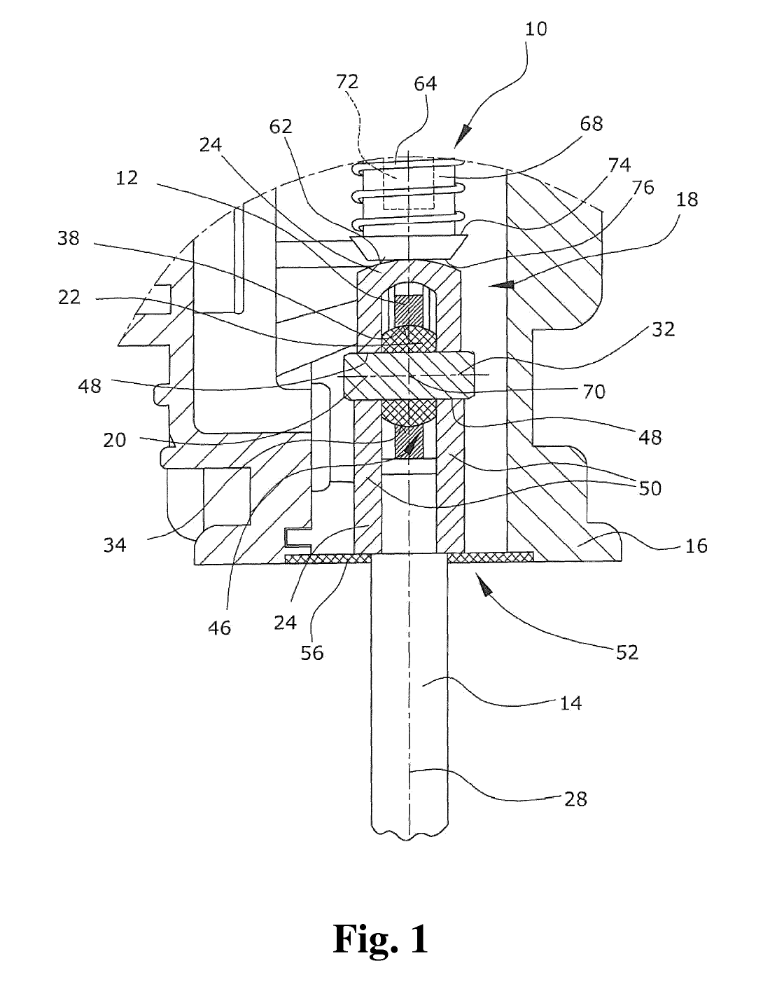

The drive element 12 has a shaped through hole 46 formed therein, which has a circular arc shaped inner contour 38 as illustrated in FIG. 1. In this shaped through hole 46, a spherical ring shaped bushing 22 of plastic material with an outer contour 34 corresponding to the circular arc shaped inner contour 38 of the shaped through hole 46, whereby the bushing 22 is supported in the shaped through hole 46 in the drive element 12 for pivotal movement about the pivot axis 30, whereby it is possible to compensate an offset between the actuating device and a valve to be actuated via the actuating element 14, which offset is caused by manufacture and results in tensions.

A cylindrical bearing pin 20 is rotatably arranged in the bushing 22, which bearing pin 20 has the same central axis 28 as the bushing 22. On either side, the bearing pin 20 projects into bores 48 in legs 50 of a U-shaped rod head 24 and is fixedly connected therewith. The bushing 22 is secured against axial displacement by means of the two legs 50 of the rod head 24 that contact the bushing 22 on either side.

The end of the actuating element 14 opposite the rod head 24 protrudes outward through a housing opening 52. The housing opening 52 is substantially formed as a through bore whose diameter, however, is larger than that of the actuating element 14 so that the latter can make a tilting movement within the housing opening 52. The housing opening 52 is closed with an elastomeric ring 56 fixed in the housing opening 52 in the housing 16, the elastomeric ring 56 radially surrounding the actuating element 14, while at the same time allowing for a tilting movement of the actuating element 14.

A surface 62 of the rod head 24 has a spherical segment shaped, wherein a center 70 of the spherical segment shaped surface 62 is the intersection of the pivot axes 30 and 32. The surface 62 is biased towards the actuating element 14 by a carrier element 68, the carrier element 68 surrounding a guide (not illustrated) formed in the housing 16 and translationally movable in the main direction of movement of the actuating element 14 and containing at least one magnet 72. A spring 64 in the form of a helical spring is the carrier element 68 and is arranged in the housing 16 to surround the guide, wherein one end of the spring 64 abuts against the housing 16 and the other end rests on a circumferential projection 74 of the carrier element 68 so that the carrier element 68 is pressed towards the rod head 24. The surface 76 of the carrier element 68 that biases the surface 62 of the rod head 24 is plane. A non-illustrated receiver element in the form of a Hall sensor is arranged in the housing 16, which measures the position of the magnet 72, whereby the position of the actuating element is determined in a manner known per se.

When the drive unit 8 is activated, the transmission rotationally operates the input shaft and, together with the same, also the eccentric 40. The eccentric output bolt 42 thereby moves around the input shaft along a circular arc, with the bearing arranged on the eccentric output bolt 42 rolling in the slotted guide plate 44, whereby the drive element 12 rotates about its rotational axis. The bushing 22 guided in the shaped through hole 46 in the drive element 12 is thus moved around the rotational axis of the drive element 12 along a circular arc-shaped path.

The rotational axis and the bushing 22 are arranged so that the circular arc-shaped path, along which the bushing 22 moves, has a clearly more important component in the main direction of movement of the actuating element 14 than in a direction perpendicular thereto. The actuating element 14 is correspondingly moved along the central axis 28 via the rod head 24 and the bushing 22. The circular arc-shaped path at the same time causes a slight tilting movement about pivot axis 32.

Since the surface 62 of the rod head 24 has a spherical segment-shaped contour, around the center 70 of which the actuating unit 18 pivots, the pivoting causes no displacement of the carrier element 68. Only the translational main movement is transferred onto the carrier element 68 and is measured with the Hall sensor. Similarly, a pivoting movement around the pivot axis 30, which may be caused by manufacturing and assembly tolerances, is compensated by the surface.

An exact measurement of the adjustment path of the actuating element is thus achieved with only a single sensor.

It should be clear that the scope of protection of the present application is not restricted to the embodiments described. In particular, various applications of the actuating device are conceivable and also the structure of the device can be modified. It should accordingly be clear that any translational movement of an element, superimposed by a pivoting movement, can be detected in this manner by a corresponding design of the point of support. The present invention is not limited to embodiments described herein; reference should be had to the appended claims.

What is claimed is:

1-18. (canceled)

19. An actuating apparatus comprising:
a housing;
an actuating unit comprising a first end with a circular arc-shaped contour whose circular arc central axis is configured to act as a first pivot axis, the actuating unit being configured to be moved via an actuator and to undertake a translational main movement and a pivoting movement, the translational main movement being superimposed by the pivoting movement;
a receiver element fixedly arranged in the housing; and
a transmitter element comprising a magnetic field, the transmitter element being configured to be translationally movable, to be biased so as to bear against the first end of the actuating unit, and to cooperate with the receiver element.

20. The actuating device as recited in claim 19, further comprising a cylindrical bearing pin, wherein the first pivot axis is a central axis of the cylindrical bearing pin.

21. The actuating device as recited in claim 19, wherein the transmitter element is a magnet or a carrier element comprising a magnet.

22. The actuating device as recited in claim 19, further comprising a second pivot axis arranged so as to be orthogonal to the first pivot axis, wherein the first end of the actuating unit comprises a surface having a spherical segment-shape, a center of the surface being an intersection of the first pivot axis and the second pivot axis.

23. The actuating device as recited in claim 19, further comprising an actuating element, wherein the first end of the actuating unit is a rod head fixed to the actuating element.

24. The actuating device as recited in claim 19, wherein the transmitter element is at least partially hollow and is closed at a side facing the actuating unit.

25. The actuating device as recited in claim 19, further comprising a stationary guide for the transmitter element arranged in the housing.

26. The actuating device as recited in claim 25, wherein the stationary guide is formed integrally with the housing.

27. The actuating device as recited in claim 25, further comprising a resilient element configured to directly or indirectly bias the transmitter element against the first end of the actuating unit.

28. The actuating device as recited in claim 27, wherein the resilient element is a spring.

29. The actuating device as recited in claim 28, wherein the stationary guide is configured to at least partially surround the spring, and the spring is arranged to abut against the housing.

30. The actuating device as recited in claim 28, wherein the spring is configured to at least partially surround the stationary guide.

31. The actuating device as recited in claim 28, wherein the transmitter element comprises a circumferential protrusion along a side facing the actuating unit, the spring being configured to bias the circumferential protrusion.

32. The actuating device as recited in claim 25, wherein the transmitter element is configured to at least partially surround the stationary guide.

33. The actuating device as recited in claim 25, wherein the stationary guide is configured to at least partially enclose the transmitter element.

34. The actuating device as recited in claim 21, further comprising a thermally insulating element arranged between the magnet and the actuating unit.

35. The actuating device as recited in claim 34, wherein the thermally insulating element is formed integrally with the rod head or with the transmitter element.

36. The actuating device as recited in claim 19, wherein the receiving element is cast or injection molded into the housing.
